(19) United States
(12) Patent Application Publication
(10) Pub. No.: US 2003/0236690 A1
(43) Pub. Date: Dec. 25, 2003

(54) Generation of executable processes for distribution

(75) Inventors: Duncan Johnston-Watt, Kent (GB); Andrew Martin West, Hampshire (GB); Gary Brown, Herts (GB); Stephen Sean Mark Ross-Talbot, West Sussex (GB)

Correspondence Address: BEYER WEAVER & THOMAS LLP, P.O. BOX 778, BERKELEY, CA, 94704-0778, US

(73) Assignee: Enigmatec Corporation

(21) Appl. No.: 10/447,497

(22) Filed: May 29, 2003

Related U.S. Application Data
(60) Provisional application No. 60/384,443, filed on May 29, 2002.

(51) Int. Cl. G06F 17/60

(52) U.S. Cl. 705/7

(57) ABSTRACT

There is provided a method for transforming business processes into executable sub-programs suitable for execution in target environments, and preferably in distributed heterogeneous target environments. A business process definition is either provided in an internal canonical form or decomposed into that canonical form from any one of a range of notations. The business processes can be stored in the canonical format. By generating executable sub-programs from the business process definition in dependence upon a generator descriptor that corresponds to the target environment, the executable sub-programs can be directly executed on the target environment. The method provides a development time environment in which business processes can be designed, modified, stored in a repository and transformed into directly executable sub-programs. The method permits the invocation of a business process in the context of the invoked program without reference to an engine or server.

### FIELD OF THE INVENTION

The present invention relates to the generation of distributed processes, and in particular to the description of processes in high-level notation resulting in the generation of specific code that operates in a distributed heterogeneous environment. The present invention is therefore particularly suitable for addressing those issues associated with the design, implementation, operation and management of enterprise and intra-enterprise business logic and extra-enterprise business services logic to ensure that the enterprise derives the maximum business benefit across a heterogeneous distributed set of computational devices.

### BACKGROUND OF THE INVENTION

Attempts have been made to automate the implementation and operation of business logic. These attempts have often been based upon the use of a particular class of declarative statements known as “rules”. Certain conventional rules-based business logic systems make use of a specific subclass of rules that can infer facts from data without the need to be told how. These “classical” business rules are called “deductive rules” or “inference rules” in the literature, and are characterised as being data-centric. They have been the dominant force in rules technology.

Deductive rules technology has been used for a number of years and is based on inferencing technology using the commercially known RETE algorithm (see for instance, http://www.pst.com/rete.htm). This technology has two primary requirements: rule engines to interpret and execute the inference based rules; and specialist skills in knowledge acquisition and rule design.

The consequence of these requirements is that heavyweight processors, needing large amounts of data and processing power, are generally required. Additionally, there is a lack of intuitive interfaces for defining rules. These factors have acted to limit the market for deductive rules.

In recent years, interest has increased in another subclass of rules, termed “reactive rules”. Reactive rules are a subclass of rules that are distinct from classical business rules. They are characterised as being event-centric and are reactive in the sense that they will monitor events and can be invoked in response to one or more events.

In the following discussion: the terms “computational entity” and “process” are used to denote a form of serialised computation that is enclosed by some boundary in which inputs and outputs are well defined and in which inputs and outputs are achieved by message passing; the term “message passing” is synonymous with the notion of “sending and receiving of events”; and a “high-level notation” is any declarative notation that describes both external and internal behaviour of one or more processes. The descriptions of external and internal behaviour are non-turing-complete descriptions of observable behaviour and turing-complete descriptions of non-observable behaviour, respectively. Finally, the term specific code applies to a description of a serialised computation that is compiled for execution on a specific platform or platforms.

A business process is a computational entity that defines or constrains some aspect of an enterprise. It imposes structure or asserts control that influences the behaviour of the enterprise. In the context presented here, a description of “business processes” includes not only classical business logic descriptions (deductive rules) and reactive rules but also computational entities such as UML modelling notations, business mark-up languages and proprietary notations. In the present invention, the scope extends beyond the business application level, to include middleware, network and other operational levels.

A business process might be a statement that defines the discount for purchasing a product in certain quantities: in other words, a process which is operating on the information which is immediately to hand. Another example of a business process is where a transaction amount is greater than some predefined limit and the computation has to be redirected to a risk analysis process, i.e. a computational entity responsible for risk analysis. While the examples given above are business processes that operate at a business application level, there are examples of using business processes to implement business transactions or business transaction co-ordination at a number of different application levels. The application of business processes, as noted above, goes beyond implementations at the business application level, an example being a business process that defines how a network element might respond to some exception condition: that is to say, business processes, as described here, cover all aspects of an enterprise's business logic, whatever that business might be.

One of the primary drivers for using business processes is the expression of business logic, as computational entities, and their interaction, the interaction through inputs and outputs between these computational entities, in a form that can be readily used and understood. This enables more efficient business logic development and shortens the time to market for deployment of new and modified business logic. Another driver is the movement towards highly event driven business. In today's Internet business environment, B2B, B2E, B2C and all of the associated processing models are event driven. Accordingly, a significant portion of business logic of these systems can be expressed as reactive behaviour in which reactions are based on interaction between business processes.

Current implementations of business logic as applications or within application servers or even business rules engines all have a server-centric physical layout. Even those known systems that attempt to implement reactive rules, in the form of ECA rules, have an engine-driven architecture. Conventional business logic systems do not, therefore, address the fundamental interaction between business processes. The resulting business logic systems are centralised, and require large amounts of data and processing power. These systems are difficult to deploy into distributed heterogeneous and embedded environments. They either deploy into a server- or engine-based model or their platform support is limited to a particular programming environment (e.g. Java with the Java Enterprise Edition (J2EE) and Java Standard Edition (J2SE) environments). In the latter case, no account is taken of the capabilities of the target environment. Neither deployment supports a distributed heterogeneous environment.

### SUMMARY OF THE INVENTION

According to one aspect of the present invention, there is provided a method for transforming business processes into executable sub-programs suitable for execution in a target environment, the method comprising the steps of: providing a business process definition; providing a generator descriptor corresponding to the target environment; and generating executable sub-programs from the business process definition in dependence upon the generator descriptor.

One benefit of the method is the facility to invoke a business process in the context of the invoked program without reference to an engine or server.

Current implementations of business logic systems are engine based and may use inference type business rules, i.e. deductive rules, or may use application servers in which target code is deployed. This means that there is a central system that requires large amounts of data and processing power. These systems are difficult to deploy into distributed heterogeneous and embedded environments. This invention solves these problems by transforming business processes into atomically executable code, which is easy to deploy and invoke in distributed heterogeneous and embedded environments by explicitly capturing the interactive messaging passing behaviour of business processes as well as their logic.

In the present invention, the term “target environment” encompasses information about the architecture and services available on a target platform (the combination of hardware processor and operating system), the preferred native language for the target platform and the capabilities of runtime context available on the target platform. Where runtime context is provided to support a standard environment for the business process execution, the amount of source code that has to be generated can be reduced. Runtime context includes, for example, one or more of: the available programming environments, the available event systems and accessibility to local files and services, and other dependencies in the target platform (dependencies such as third party components or legacy systems). An event system is a system which dispatches events in some form, for example Java Message Service, Java Listener service, or Windows event dispatcher, X windows, etc.

The business process definition may be provided in the form of a reactive rule definition. Alternatively or additionally, the business process definition may be provided in an internal canonical form. When the business process definition is not provided in an internal canonical form, the step of generating executable sub-programs may include parsing the business process definition into the internal canonical form. Preferably, the internal canonical form is the Reactive Intelligence Framework Mark-up Language (RIFML).

Advantageously, the step of generating executable sub-programs includes: generating source code for the executable sub-programs using one or more transformation rules in combination with one or more generator descriptors that describe the target environment.

The transformation is generally a multi-stage process.

The step of generating executable sub-programs may further include invoking one or more compilers to generate an executable form of the business process from the source code.

Using Java as an example, the internal form of the representation is common to all targets, Java source is generated in a code generation step, and the subsequent executable form is a Java class file.

The sub-programs generated in the generating step are advantageously generated in dependence upon a runtime context thereby supporting a standard environment for the business process execution. The runtime context may include: available programming environment data; available event systems data; data regarding accessibility to local files and services; and data concerning other dependencies in the target platform. The term “event system” denotes a system that dispatches events in a predetermined form, selected from a group including: Java Message Service, Java Listener service, Windows event dispatcher, and X windows messaging.

The generator descriptor preferably includes data selected from one or more of: a list of available programming environments; a list of available event models; processor data, which represents the hardware in use in the target environment; operating system data, which indicates the type of operating system in use in the target environment; and a list of dependencies.

Where the programming environment is Java [RTM] based, the edition of Java on the target platform, i.e. J2EE, J2SE, J2ME or RTJS, would be specified.

The generator descriptor provided may be user input at the time of definition of the business process. In this case, the user-input generator descriptors may be entered by a user knowledgeable in the details of the target platform.

In a preferred embodiment, the step of providing a generator descriptor includes providing a set of common generator descriptors for commonly occurring target environment configurations.

Alternatively or additionally, the generator descriptor may be inferred. The generator descriptor may be inferred at least partially from one or more of: the business process definition and runtime context.

It is preferred that, the method further includes the step of maintaining a library of business process definitions in a process store. The business process definitions may be stored in an internal canonical form. On the other hand, the business process definitions may be provided by a user via a user interface that accesses the process store. Where the latter in the case, the step of generating executable sub-programs includes: invoking a business process transformation component to transform the user-defined business process definition into an executable form of the business process from the source code.

The step of generating executable sub-programs preferably includes deploying the executable business processes via a network to the intended target environment. The executable business processes may then be generated for each target environment present on the network and deployed at a number of different locations on the network, such that a reduced set of executable business processes is generated for delivery to, and deployment at, the different respective locations within the network.

In accordance with another aspect of the invention, there is provided a system for transforming business processes into executable sub-programs in accordance with a business process definition and a generator descriptor for a target environment, wherein the system comprises one or more computer applications that provide an interface for the input of business process definitions and transform one or more business process definitions into a number of sub-programs for execution within the target environment in dependence on the generator descriptor.

According to yet another aspect of the present invention, there is provided a computer program product comprising computer executable code that is operative to convert a business process definition to one or more executable sub-programs in dependence on one or more generator descriptors, each of said generator descriptors corresponding to a target environment.

The invention therefore provides a method for transforming business processes into executable sub-programs suitable for execution in target environments, and preferably in distributed heterogeneous target environments. A business process definition is either provided in an internal canonical form or decomposed into that canonical form from any one of a range of notations. The business processes can be stored in the canonical format. By generating executable sub-programs from the business process definition in dependence upon a generator descriptor that corresponds to the target environment, the executable sub-programs can be directly executed on the target environment. The method provides a development time environment in which business processes can be designed, modified, stored in a repository and transformed into directly executable sub-programs. The method permits the invocation of a business process in the context of the invoked program without reference to an engine or server.

### BRIEF DESCRIPTION OF THE DRAWINGS

Examples of the present invention will now be described in detail with reference to the accompanying drawings, in which:

FIG. 1 shows a high level schema of the system level operation; and,

FIG. 2 shows a business process transformation process in accordance with the present invention; and,

FIG. 3 shows an example of a specific network distribution of an executable business process.

### DETAILED DESCRIPTION

The present invention provides what we call a Reactive Intelligence Framework (RIF). The invention provides a development time environment in which business processes can be designed, modified, stored in a repository and transformed into directly executable sub-programs. These sub-programs may be invoked by a variety of means. The business processes are stored in a canonical eXtended Markup Language (XML) format.

There are a number of known notations for expressing business processes, examples include: notations used for the construction of UML models; proprietary notations (e.g. AMIT's Situation Markup Language); business process markup languages (e.g. BPML, BPEL4WS and BPSS); and business rules (e.g. Event Condition Action (ECA) rules in RuleML).

UML, Universal Modelling Language, notations are used by programmers who use integrated development environments (e.g. Rationale Rose) to create and store their models. One example of such a notation, XMI, allows the programmers to create applications from models that are stored as XMI documents.

Proprietary notations, for example AMIT's Situation Markup Language, are used to express complex situations for monitoring event streams and changes in databases.

Business process markup languages (e.g. BPML, BPEL4WS and BPSS) can be used for declaratively expressing a business process as a choreography or orchestration of business processes in a manner similar to workflow.

Business rules (e.g. Event Condition Action (ECA) rules in RuleML) have been used to provide standards based descriptions of the monitoring of event streams and changes in databases and allow rule exchange to take place amongst heterogeneous but standards compliant business rule environments.

We will use the ECA rules notation as an example without loss of generality. In this notation, a business process is expressed as: an event definition, which describes the event or events the containing process will handle, as inputs; a condition definition, which describes the tests that will be applied; and one or more action definitions, which describe the possible actions of this process and may embody the outputs that this process performs. The event definition provides an event algebra that includes the support for temporal events and event correlation. Condition definitions may operate on event data, local data or temporally related events.

The business processes are defined and manipulated via an interface, for example an API. The interface may incorporate a user interface whereby a user can input data describing the underlying business logic. Additionally, or alternatively, the interface may incorporate a feed interface through which predefined business logic is transferred.

The business processes are transformed into executable code using a generator that selects the appropriate programming language for the target platform and environment. The preferred language will be Java. The Java language provides wide support from the server environment of Java Enterprise Edition (J2EE), the workstation environment with Java Standard Edition (J2SE), through the mobile environment of Java Mobile Edition (J2ME), to the embedded environment with Real Time Java Specification (RTJS). Other potential languages include C#, C and languages that are conformant to the Common Language Runtime (CLR) where the application or platform requires this support.

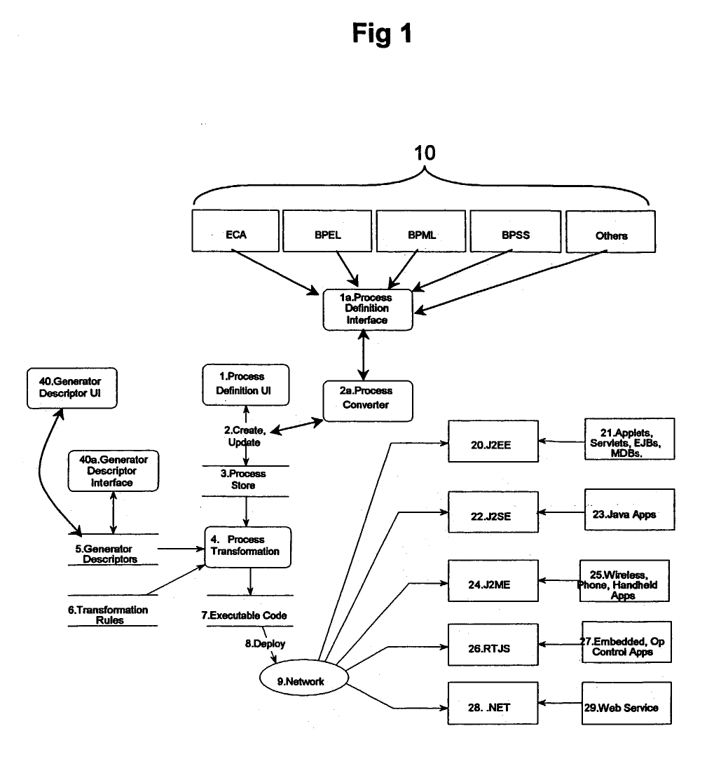

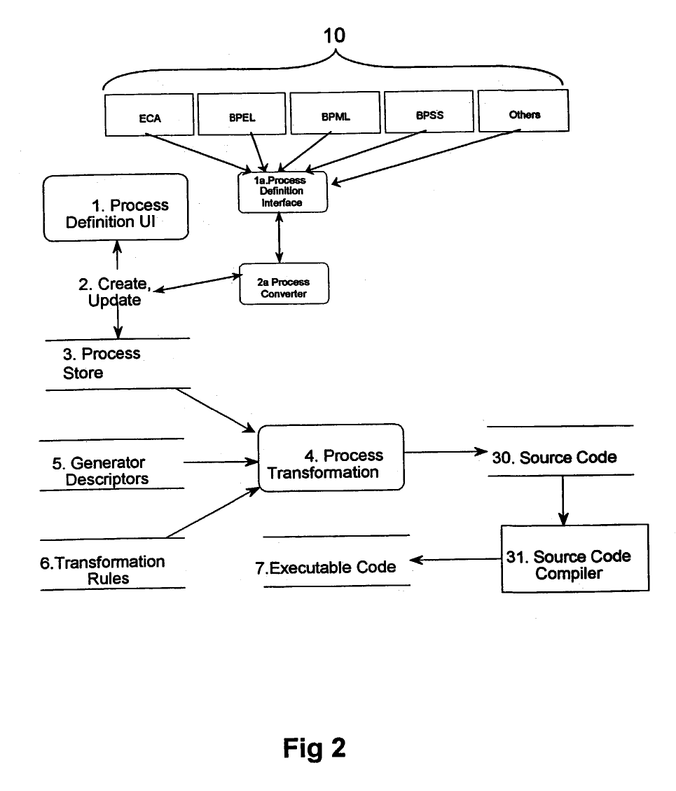

As shown in FIGS. 1 and 2, a business process definition is created by a user defining business processes via a user interface 1 or through the importation of any other notation or types of notation 10 described above (e.g. BPEL, BPML, XMI, ECA, etc.). If the business processes are defined in another notation 10, and so use the process interface 1a, a subsequent conversion takes place from the original notation to the canonical form, 2a. The process interface 1a is an application programming interface (API) that allows other notations 10 to be captured through the invocation of an application that uses that application programming interface and passes it through to the conversion process, 2a. Regardless of the route by which a business process is created, the system maintains 2 a library of business processes in a process store 3. These business processes are stored as XML documents in a canonical form. One canonical form is embodied by RIFML, which is a proprietary mark-up language for the encoding of processes. This embodiment is provided without loss of generality. A business process transformation component 4 transforms the business process into executable code 7 from the canonical form. The transformation may be a multi-stage process. A business process definition is read from the process store 3 and using one or more generator descriptors 5 and one or more transformation rules 6, the source code 30 for an executable sub-program is generated. The generator descriptors 5 that are used can be selected either specifically by the user from a list of available generator descriptors presented by the user interface 1 or automatically from a predefined list. The generator descriptors and predefined lists are defined by a system administrator using a separate user interface 40 or by using the generator descriptor interface, which is an application programming interface, 40a. The appropriate compiler 31 for the source is then invoked to generate the executable form 7 of the business process.

As mentioned earlier a generator descriptor describes the characteristics of the target platform. It may contain data relating to one or more of the following: a list of available programming environments and the preferred programming environment, the hardware processor and the operating system, and a list of dependencies. In the case of Java, the edition of Java on the target platform, i.e. J2EE, J2SE, J2ME or RTJS, would be specified.

The runtime context is provided to support a standard environment for the business process execution and so minimise, or at least reduce, the amount of source code that has to be generated. These executable business processes are then deployed 8 via a network 9 to the intended target platform. In a preferred implementation, these platforms can be any that support Java or CLR, because of their wide support and distributable nature.

In FIG. 1 there are five target environments as an illustration:

Java Enterprise Edition 20 in which environments the business processes can be invoked by Applets executing in web browser; servlets, Enterprise Java Bean (EJB) and Message Driven Bean (MDB) running in an application server 21.

Java Standard Edition 22 in which environments the business processes can be invoked by standalone Java applications 23.

Java Mobile Edition 24 in which environment the business processes can be invoked by wireless, phone and handheld applications 25.

Real Time Java Specification 26 in which environment the business processes can be invoked by embedded and operational control applications 27.

.NET 28 in which environment the business processes can be invoked by web services 29.

The business processes can be invoked directly by one of the kinds of application described above or they can be invoked from an underlying event model. In the present invention, a context is provided in the runtime environment which provides a generalised event model and other functions that support the execution of the business processes. The context provides a generalised event handling mechanism that is an abstraction of an event model. The data requirements are minimised using information in the event and providing local data access capabilities in the context.

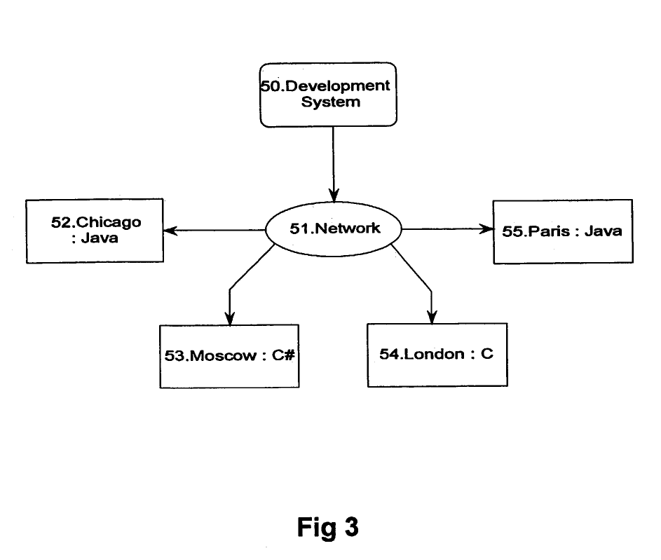

FIG. 3 shows an instance of a physical network in which a unit of business logic defined by a business process is deployed to four different and disparate platforms. Node 52 which is physically in Chicago is running Java in a J2EE environment; Node 53 is in Moscow and is running C# in a web services environment; node 54 is in London and is running a C embedded environment and finally node 55 is in Paris which is running Java in a J2SE environment. The logic and behaviour of each executable in each of the environments is the same and is as specified in the definition of the business process. In this example, we have introduced a target environment not included in the predefined target environments listed above (the embedded C environment at node 54) as a way of illustrating the mechanism to extend the target environments. In FIG. 2, the additional target environment (node 54) is defined via a user interface 40 (see FIG. 1) by a system administrator and the resulting generator descriptor is stored in a repository of generator descriptors 5. The system administrator will also define lists of deployment of descriptors for use by the user defining the business processes.

The following example of a business process definition shows the definition of the business process using an ECA syntax. The business process states that for an instrument price change event if the price of the instrument falls below a specified value then perform a sell operation on all the holdings of this instrument for a specified customer.

<Event name=“PriceChange” type=“InstrumentPriceChange”>

<Condition>

<AND>

<EQ>

<operand name=“PriceChange.instrument”/>
<literal value=“US00038564765”/>

</EQ>
<LT>

<operand name=“PriceChange.price”/>
<literal value=“75.5”>

</LT>

</Condition>
<Action>

<Declare name=“Trades” type=“TradeList”/>
<Assign name=“Trades”>

<Call context=“TradeSys” operation=“getTrades”>

<param name=“Custimer” value=“XYZ Bank”/>
<param name=“Instrument”

operand=“PriceChange.instrument”\>

</Call>

</Assign>
<Loop control=“Trades” item=“Trade”>

<Call context=“TradeSys” operation=“Sell”>

<param name=“Trade” operand=“Trade”/>

</Call>

</Loop<

</Action>

</Event>
An alternative syntax where the generator has more knowledge of the

system might be:

<Customer name=“XYZ Bank”>

<instrument id=“US00039564765”>

<low value=“75.5”>

<behaviour name=“sell”/>

</low>

</instrument>

</Customer>
The generated source code is the same . . .

JAVA VERSION:
package expamplerules;
public MonitorInstrument() {
}
public void onEvent(Object event) {

com.acme.InstPriceChange priceChange=

(com.acme.InstPriceChange)event;

if (priceChange.getInstrument().equals(“US00039564765”) &&

priceChange.getPrice() < 75.5) {

java.util.Vector trades=TradeSys.getTrades(“XYZ Bank”,

priceChange.getInstrument());

for (int=0; i < trades.size(); i++) {

com.acme.Trade trade=

(com.acme.Trade)trades.elementAt(i);

TradeSys.sell(trade);

}

}

}

}
C#VERSION:
using System;
namespace ExampleRules
{

public class MonitorInstrument : com.enigmatec.ReactiveRule {

public MonitoringInstrument() {
}
public void onEvent(Object event) {

com.acme.InstPriceChange priceChange=

(com.acme.InstPriceChange)event;

if (priceCange.getInstrument().equals(“US00039564765”)

&& priceChange.getPrice() < 75.5) {

com.acme.Trade[] trades=TradeSys.getTrades(“XYZ Bank”,

priceChange.getInstrument());

foreach (com.acme.Trade trade in trades)

TradeSys.sell(trade);

}

}

1. A method for transforming business processes into executable sub-programs suitable for execution in a target environment, the method comprising the steps of:
providing a business process definition;
providing a generator descriptor corresponding to the target environment; and
generating executable sub-programs from the business process definition in dependence upon the generator descriptor.

2. A method as claimed in claim 1, wherein the business process definition is provided in the form of a reactive rule definition.

3. A method as claimed in claim 1, wherein the business process definition is provided in an internal canonical form.

4. A method as claimed in claim 1, wherein the step of generating executable sub-programs Includes:
parsing the business process definition into an internal canonical form.

5. A method as claimed in claim 3 wherein the internal canonical form is Reactive Intelligence Framework Mark-up Language (RIFML).

6. A method as claimed in claim 1, wherein the step of generating executable sub-programs includes:
generating source code for the executable sub-programs using one or more transformation rules in combination with one or more generator descriptors that describe the target environment.

7. A method as claimed in claim 6, wherein the step of generating executable sub-programs further includes:
invoking one or more compilers to generate an executable form of the business process from the source code.

8. A method as claimed in claim 1, wherein the sub-programs generated in the generating step are generated in dependence upon a runtime context thereby supporting a standard environment for the business process execution.

9. A method as claimed in claim 8, wherein the runtime context includes one or more of: available programming environment data; available event systems data; data regarding accessibility to local files and services; and data concerning other dependencies in the target platform.

10. A method as claimed in claim 9, wherein an event system is a system which dispatches events in a predetermined form, selected from a group including: Java Message Service, Java Listener service, Windows event dispatcher, and X windows messaging.

11. A method as claimed in claim 1, wherein the generator descriptor includes data selected from one or more of: a list of available programming environments; a list of available event models; processor data, which represents the hardware in use in the target environment; operating system data, which indicates the type of operating system in use in the target environment; and a list of dependencies.

12. A method as claimed in claim 1, wherein the generator descriptor is user input at the time of definition of the business process.

13. A method as claimed in claim 1, wherein the step of providing a generator descriptor includes providing a set of common generator descriptors for commonly occurring target environment configurations.

14. A method as claimed in claim 1, wherein the generator descriptor is inferred.

15. A method as claimed in claim 14, wherein the generator descriptor is inferred at least partially from one or more of: the business process definition and runtime context.

16. A method as claimed in claim 1, further including the step of maintaining a library of business process definitions in a process store.

17. A method as claimed in claim 16, wherein the business process definitions are stored in an internal canonical form.

18. A method as claimed in claim 16, wherein the business process definition is provided by a user via a user interface that accesses the process store.

19. A method as claimed in claim 18, wherein the step of generating executable sub-programs includes:
invoking a business process transformation component to transform the user-defined business process definition into an executable form of the business process from the source code.

20. A method as claimed in claim 1, wherein the step of generating executable sub-programs includes deploying the executable business processes via a network to the intended target environment.

21. A method as claimed in claim 20, wherein the executable business processes are generated for each target environment present on the network and are deployed at a number of different locations on the network, such that a reduced set of executable business processes is generated for deployment at the different respective locations within the network.

22. A system for transforming business processes into executable sub-programs in accordance with a business process definition and a generator descriptor for a target environment, wherein the system comprises one or more computer applications that provide an interface for the input of business process definitions and transform one or more business process definitions into a number of sub-programs for execution within the target environment in dependence on the generator descriptor.

23. A system as claimed in claim 22, wherein the business process definition is provided in the form of a reactive rule definition.

24. A system as claimed in claim 22, wherein the business process definition is provided in an internal canonical form.

25. A system as claimed in claim 22, wherein the generator descriptor is user input at the time of definition of the business process where a suitable generator descriptor is not present in the set of common generator descriptors.

26. A system as claimed in claim 22, wherein the generator descriptor is selected from a set of common generator descriptors for commonly occurring target environment configurations.

27. A system as claimed in claim 22, wherein the generator descriptor used in the generation of executables is inferred.

28. A system as claimed in claim 27, wherein the generator descriptor is inferred at least partially from one or more of: the business process definition and runtime context.

29. A system as claimed in claim 22, wherein the one or more computer applications include: a computer application that parses the business process definition into an internal canonical form; and a computer application that generates source code for the executable sub-programs using one or more transformation rules in combination with one or more generator descriptors that describe the target environment.

30. A system as claimed in claim 29, wherein the computer applications further include a computer application that invokes one or more compilers to generate the executable form of the business process from the source code.

31. A computer program product comprising computer executable code that is operative to convert a business process definition to one or more executable sub-programs in dependence on one or more generator descriptors, each of said generator descriptors corresponding to a target environment.
